(19) United States
(12) Patent Application Publication
(10) Pub. No.: US 2010/0104097 A1
(43) Pub. Date: Apr. 29, 2010

(54) SYSTEM AND METHOD FOR UCC CONTENTS PROTECTION

(75) Inventors: Jae-Seok Jang, Seoul (KR); Seog-Cheon Jeon, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: KT CORPORATION, SEONGNAM-CITY, KYEONGGI-DO (KR)

(21) Appl. No.: 12/529,531

(22) PCT Filed: Feb. 27, 2008
(86) PCT No.: PCT/KR08/01130

§ 371 Date: Sep. 1, 2009

(30) Foreign Application Priority Data
Mar. 2, 2007 (KR) 10-2007-0020959

(51) Int. Cl. H04L 9/20; G06F 21/00

(52) U.S. Cl. 380/46; 726/26; 380/277; 380/44

(57) ABSTRACT

The present invention relates to a user created contents protection system and method. Copyright protection for protecting contents on user created contents is performed by using a contents upload server or a user terminal including a digital rights management (DRM) packager. Therefore, copyright protection of the user created contents is performed, and a user that legally provides user created contents can be rewarded. Also, when illegally distributed user created contents are generated, a person having initially attempted to distribute the contents is tracked to clarify responsibility.

### TECHNICAL FIELD

The present invention relates to a contents protection system and method, and in particular, it relates to a contents protection system and method for user created contents.

### BACKGROUND ART

As the Internet has been substantially developed, the digital contents industry has also been developed because the digital contents have been activated through means of the Internet. However, side effects have been generated according to the development of the digital contents industry, such as illegal reproduction or distribution of digital contents.

Particularly, when many people share the contents with other people on the Internet, some users duplicate the source contents without acquiring permission or illegally link and use the address of the site on which contents are disclosed. Further, in the case of user created contents (UCC) for generating new contents by using source contents, the copyright for the source contents cannot be protected, and it is difficult to clarify where the responsibility lies regarding the user who has illegally distributed the contents.

### DISCLOSURE

### Technical Problem

The present invention has been made in an effort to provide a contents protection system and method for protecting the copyright UCC generated by a user.

### Technical Solution

In one aspect of the present invention, a contents protection system in a system for protecting user created contents generated by a user terminal includes: a decoder for checking encoding information on first user created contents generated by the user terminal; a resize filter for resetting the size of the first user created contents to be reproducible; an encoder for encoding the first user created contents by using codec information supported by a predetermined viewer and outputting second user created contents so that the first user created contents with the reset size may be reproduced under a condition in which the predetermined viewer is installed; and a packager for encrypting the output second user created contents by using contents identification (CID) information and an encryption key generated based on provider information of the first user created contents.

In another aspect of the present invention, a contents protection method in a method for protecting user created contents generated by a user terminal includes: checking codec information applied to first user created contents generated through the user terminal; encoding the first user created contents and outputting the encoded first user created contents as second contents by using codec information for reproducing the first user created contents under a condition in which a predetermined viewer for reproducing the first user created contents is positioned; receiving contents identification (CID) information corresponding to the first user created contents and a contents encryption key corresponding to the second user created contents, the CID information being generated based on user information on the user having generated the first user created contents; and encrypting and outputting the second user created contents based on the CID information and the contents encryption key.

In another aspect of the present invention, a contents protection system in a system for protecting user created contents includes: a contents processor for converting first user created contents generated from source contents into second contents and outputting the second contents so as to be reproduced in a predetermined viewer; and a contents reproducer for receiving the second user created contents from the contents processor, and reproducing the second user created contents through the predetermined viewer, wherein the contents processor includes a packager for encrypting the second user created contents based on the CID information and the contents encryption key to generate the encrypted second user created contents.

In another aspect of the present invention, a contents protection method in a method for protecting user created contents generated from a user terminal includes: performing first conversion on the contents generated by the user terminal based on predetermined codec information and outputting first user created contents; receiving codec information required for reproducing the contents through a predetermined viewer from a contents reproduction server in which the predetermined viewer is installed, and comparing the codec information and the predetermined codec information; encoding the first user created contents based on the codec information when the predetermined codec information does not correspond to codec information required for reproducing contents through the viewer, and generating second user created contents to thus perform secondary conversion; and receiving a CID corresponding to the generated first user created contents and a contents encryption key corresponding to the second contents, and encrypting the second user created contents.

### ADVANTAGEOUS EFFECTS

According to the exemplary embodiment, the copyright for the user created contents can be protected, and the user having provided legal user created contents can be rewarded.

Further, when illegally distributed user created contents are generated, the person who initially attempted to distribute the contents can be tracked to clarify responsibility.

### DESCRIPTION OF DRAWINGS

FIG. 1 is a configuration diagram for a contents protection system according to a first exemplary embodiment of the present invention.

FIG. 2 is a flowchart for a contents protection method according to a first exemplary embodiment of the present invention.

FIG. 3 is a configuration diagram for a contents protection system according to a second exemplary embodiment of the present invention.

FIG. 4 is a flowchart for a contents protection method according to a second exemplary embodiment of the present invention.

FIG. 5 is a configuration diagram for a contents protection system according to a third exemplary embodiment of the present invention.

FIG. 6 is a flowchart for a contents protection method according to a third exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements.

A method and device for protecting the user created contents (UCC) by using digital rights management (DRM) from among a large amount of contents will be exemplified for constituent elements of the contents protection system according to an exemplary embodiment of the present invention and a contents protection method.

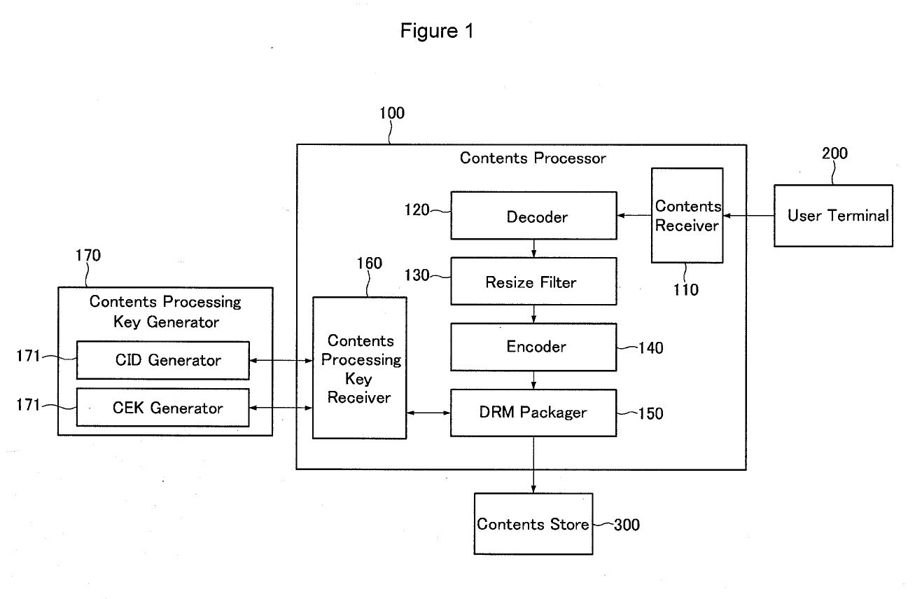

FIG. 1 is a configuration diagram for a contents protection system according to a first exemplary embodiment of the present invention.

As shown in FIG. 1, the contents protection system is connected to a user terminal 200 including a contents editor (not shown), and includes a contents processor 100, a contents storage unit 300, and a contents processing key generator 170. The contents processing key generator 170 can be realized as a part of the contents protection system and can also be realized to be separated from the contents protection system. A plurality of types of information including user contents identification (CID) information and a contents encryption key (CEK) generated by the contents processing key generator 170 are input to the contents processor 100 through a contents processing key receiver 160.

The contents processor 100 includes a contents receiver 110, a decoder 120, a resize filter 130, an encoder 140, a DRM packager 150, and the contents processing key receiver 160.

The decoder 120 receives the UCC that is edited by a contents editor from the contents receiver 110, and determines the coding format of the received UCC contents. Since various UCC received from various user terminals are coded with various types of codecs and are then transmitted, it is needed to determine the type of the codec in order to encode UCC according to the site in which a predetermined viewer is installed for providing the UCC. Here, the user terminal includes a PC and a portable mobile communication terminal, and further, devices for a user to generate UCC by using a large volume of contents will be available.

The resize filter 130 determines the size of the received UCC contents, and resets the size of the UCC in order to provide the UCC through a predetermined viewer. The encoder 140 encodes the UCC by using a format that is predefined during system design in order to provide the UCC to the user through a predetermined viewer.

The DRM packager 150 receives the UCC that are encoded with a predetermined format from the encoder 140, and encrypts the UCC so as to protect the UCC. Also, the DRM packager 150 determines whether the UCC encoded by the encoder 140 are contents that are initially uploaded to the site. In this instance, user CID information and CEK are required so as to encrypt the UCC. The user CID information and the CEK are transmitted from the contents processing key generator 170 through the contents processing key receiver 160. The contents processing key generator 170 will be described to be included in the contents protection system in the exemplary embodiment of the present invention.

A CID generator 171 logs in to a site so that the user may upload the UCC to the corresponding site in which a predetermined viewer is installed, and generates a user CID based on the user s access information when the process for encoding the UCC is finished. In this instance, the user CID is generated by matching one UCC with one user CID, and the generated user CID information is stored in the CID generator 171.

The DRM packager 150 checks information on the user who has initially uploaded the UCC based on the generated CID information, and the user information is used to check copyright protection and distribution on the UCC. In this instance, the method for generating the user CID information is well known to a person skilled in the art, and no detailed corresponding description will be provided in the exemplary embodiment of the present invention.

A CEK generator 172 generates an encryption key for encrypting UCC. In this instance, the encryption key is generated in a random manner, and is generated when the size reset and encoding process on the UCC is finished. The generated encryption key is input to the DRM packager 150 and is then used for encrypting the contents.

The contents storage unit 300 stores the UCC that are encrypted through the user CID information and the CEK. The stored UCC are reproduced in the site in which a predetermined viewer is installed, and are reproduced in another site according to the user's request.

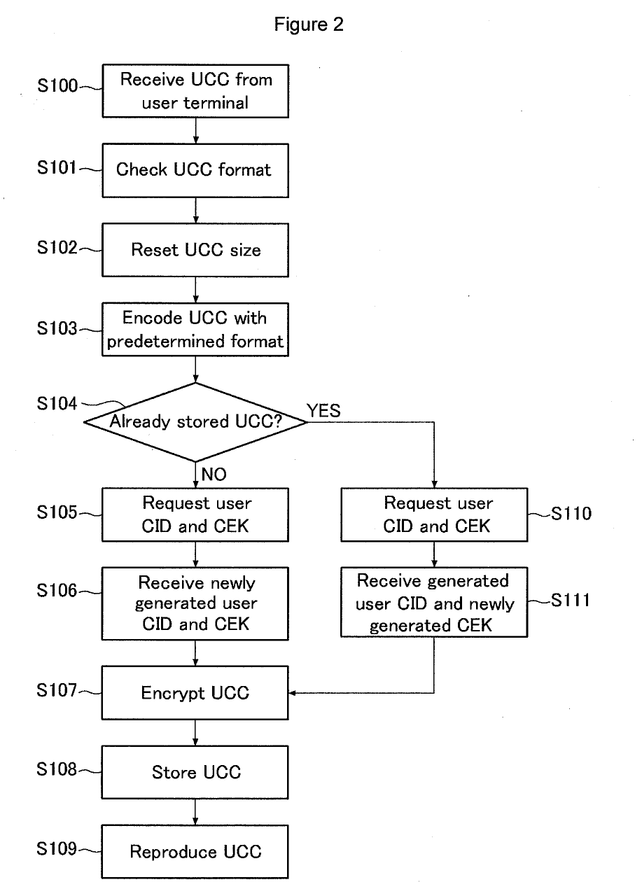

A method for protecting the UCC through a contents protection system having the above-noted constituent elements will now be described with reference to FIG. 2.

FIG. 2 is a flowchart for a contents protection method according to a first exemplary embodiment of the present invention.

The contents protection method according to the first exemplary embodiment of the present invention relates to a UCC protection method when attempting to execute the UCC provided by the user on the web. That is, the method relates to a method for a server to protect the UCC when attempting to execute the UCC on the web.

When receiving the UCC from the user terminal 200 through the contents receiver 110 (S100), the contents processor 100 checks the codec of the UCC that is the format thereof to thus determine by what format the received UCC are coded (S101). After checking the codec of the UCC, the contents processor 100 resets the size of the UCC through the resize filter 130 so that the UCC may be performed on the site in which a predetermined viewer is installed (S102). The contents processor 100 encodes the UCC by a predetermined format that is required for the server to reproduce the UCC (S103).

The encoder 140 encodes the UCC, and simultaneously the CID generator 171 and the CEK generator 172 of the contents processing key generator 170 generate a user CID and a CEK to correspond to the UCC. In this instance, the user CID is generated based on log-in information of the user who initially uploads the UCC to the server.

That is, when receiving the UCC that is encrypted to be encoded with a predetermined format and the size of which is reset, the DRM packager 150 determines whether the corresponding UCC are encrypted and stored in the contents storage unit 300 (S104). When the UCC are not stored in the contents storage unit 300, the DRM packager 150 determines that the corresponding UCC are initially uploaded to the site by the user, and requests the CID generator 171 and the CEK generator 172 to generate a user CID and a CEK (S105).

When receiving the user CID and the CEK from the CID generator 171 and the CEK generator 172 (S106), the DRM packager 150 uses the received information to encrypt the UCC (S107), and stores the encrypted UCC in the contents storage unit 300 (S108). The UCC are then reproduced in the site in which a predetermined viewer is installed and to which the user desires to upload contents (S109).

When the DRM packager 150 determines through the determination of the step S104 that the encrypted UCC are already stored in the contents storage unit 300, the DRM packager 150 requests the CID generator 171 and the CEK generator 172 to generate a user CID and a CEK (S110). In this instance, since the corresponding UCC are initially uploaded to the server by a predetermined user, the DRM packager 150 receives the CID information that is used for the initial encryption from the CID generator 171 (S111). The DRM packager 150 encrypts the UCC by using the CEK that is generated randomly for UCC encryption by the CEK generator 172 (S107).

The initially encrypted UCC are stored in the contents storage unit 300, and the UCC that are uploaded to a predetermined server are executed. Also, the UCC that are requested to be executed by the user are output by the contents storage unit 300 and are then executed. In this instance, the method for executing the UCC uploaded to one site in another site is to duplicate the URL of the site currently executing the UCC, or to download the UCC and execute the same in the desired site, and the embodiment of the present invention is not restricted to this.

Here, it is assumed that the user CID for encrypting the corresponding UCC is “111” and is reproduced in the site called “AA” when initially uploading the UCC. Then, the UCC has the identifier of “111@AA.ktf.com”. Also, assuming that the same UCC are reproduced in the site of “BB” by another user, the UCC has the identifier of “111@BB.kff.com”. That is, even when the other user uploads the same UCC to the site of “BB”, the user CID of “111” of the user who has initially uploaded the UCC is displayed on the identifier of the UCC so that the user who has initially uploaded the corresponding UCC can be checked.

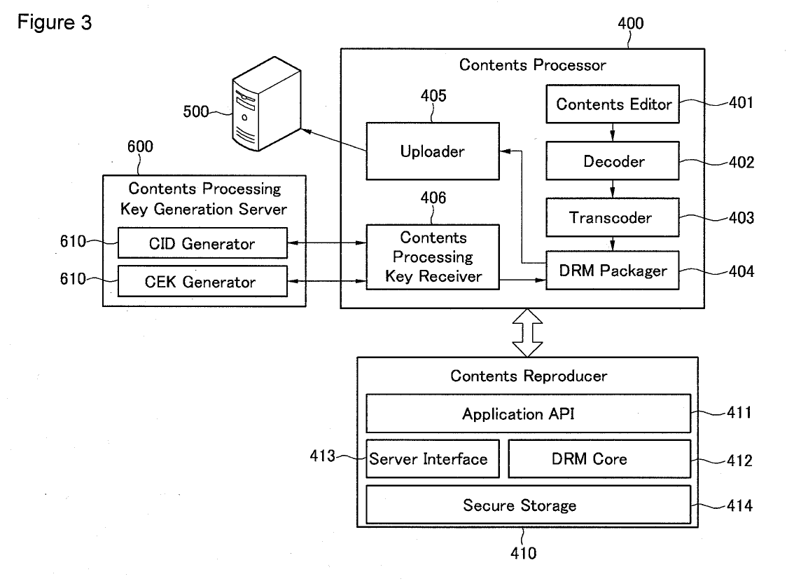

A contents protection system according to a second exemplary embodiment of the present invention will now be described with reference to FIG. 3. The second exemplary embodiment relates to a contents protection system for a user terminal to encode UCC so as to protect the contents when the user downloads the UCC to the user terminal and uses them.

FIG. 3 is a configuration diagram for a contents protection system according to a second exemplary embodiment of the present invention.

As shown in FIG. 3, in the contents protection system, a user terminal including a contents processor 400 and a contents reproducer 410 is linked with a contents upload server 500 and a contents processing key generation server 600.

The contents processor 400 includes a contents editor 401, a decoder 402, a transcoder 403, a DRM packager 404, an uploader 405, and a contents processing key receiver 406. The contents reproducer 410 includes an application API 411, a server interface 413, a DRM core 412, and a secure storage 414.

The contents editor 401 performs a function for a user to edit predetermined contents to generate UCC. The decoder 402 checks the type of the codec of the UCC generated by the contents editor 401. The transcoder 403 readjusts the size so as to reproduce the UCC, and encodes the UCC with a reproducible codec that is preset by the system.

The DRM packager 404 encrypts the UCC that are encoded by the transcoder 403 and that are to be protected as intellectual property so that only the used registered may use the UCC, and packages the UCC into a file format of the secure container. Here, the secure container represents an electronic security device for encrypting and distributing the source contents the copyright of which is to be protected. The secure container is well known to a person skilled in the art, and no corresponding detailed description thereof will be provided in the exemplary embodiment of the present invention.

In order to encrypt the UCC through the DRM packager 404, a user CID information including information on the user who initially uploads the UCC and a CEK for encrypting the UCC are required. The information is received from the contents processing key generation server 600 through the contents processing key receiver 406. The UCC encrypted by the DRM packager 404 are transmitted to the site in which a predetermined viewer is installed through the uploader 405 so that the UCC may be executed by a server, or the UCC are transmitted to the contents reproducer 410 so that the UCC may be executed by the user terminal.

The contents reproducer 410 is a module for reproducing the UCC processed by the contents processor 400. The contents reproducer 410 includes a high level command processor (not shown) for identifying various application modules that correspond to the high level commands provided by the application API 411, decoding the high level commands, and providing the high level commands to a corresponding unit.

The server interface 413 includes a right object acquisition protocol (ROAP) interface, a wireless public key infrastructure (wPKI) interface, and a metering interface. Here, the ROAP interface is an interface for acquiring a right object so as to provide the right object (RO) issued by a right issuer to a contents reproducer. The wPKI interface collects wPKI information including a certificate on the wireless network and an electronic signature key. The metering interface is used for a music service, and collects metering information such as a royalty generated according to service usage.

The DRM core 412 manages the right object and the metering information, and manages the DRM contents format (DCF) reader/writer. Here, the DCF includes a version, a length of a contents type, a length of a contents URI, a contents type, a contents URI, a length of a header, a data length, a header, and encrypted data information, which will not be described in the exemplary embodiment of the present invention since they are well known to a skilled person.

The secure storage 414 stores the CEK used for encrypting the UCC, metering information, right object, and context information. Here, the right object is information for analyzing the encrypted UCC, and it includes user information on who initially generated the contents when random UCC are second distributed contents, and a contents identification number.

The contents upload server 500 receives the converted UCC from the contents processor 400 through the uploader 405, and uploads the UCC so that the UCC may be executed in the site in which a predetermined viewer for executing the UCC is installed.

The contents processing key generation server 600 includes a CID generator 610 and a CEK generator 620. The CID generator 610 logs in to the corresponding site so that the user may upload the UCC to the site in which the predetermined viewer is installed, and generates a user CID based on the user's access information as soon as the encoding process for the predetermined UCC is finished. In this instance, a single user CID is generated to correspond to a single UCC, and the generated user CID information is stored in the CID generator 610.

The CEK generator 620 generates an encryption key for encrypting the UCC. In this instance, the encryption key is randomly generated, and is generated when the size of the UCC is reset and encoding of the UCC is finished. The generated encryption key is input to the DRM packager 404 and is then used for encrypting the UCC. Here, the encryption key uses a key that is generated by using a secret key algorithm.

The contents upload server 500 receives the processed UCC from the contents processor 400 through the uploader 405, and stores the UCC. That is, when attempting to reproduce the UCC by accessing the site in which a predetermined viewer is installed instead of using a user terminal, the user brings the UCC from the contents upload server 500 and reproduces the UCC.

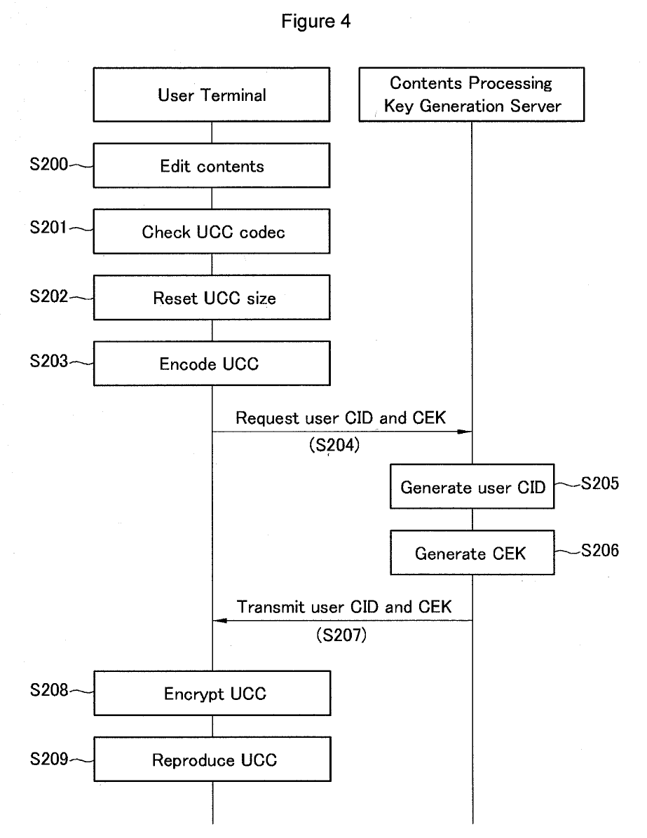

A method for protecting the UCC at the user terminal according to the above-noted constituent elements will now be described with reference to FIG. 4.

FIG. 4 is a flowchart for a contents protection method according to a second exemplary embodiment of the present invention.

As shown in FIG. 4, the user edits a plurality of contents through the contents editor 401 (S200) to generate UCC to be reproduced. The decoder 402 checks the codec to determine by which codec the generated UCC are encoded (S201). The decoder 402 resets the size of the UCC (S202) so as to reproduce the UCC through the user terminal, and encodes the UCC into a predetermined format (S203). In this instance, a predetermined viewer for reproducing the UCC is installed in advance in the user terminal.

While encoding the UCC with a predetermined format, the contents processor 400 requests a user CID and a CEK for UCC encryption from the contents processing key generation server 600 (S204). The CID generator 610 of the contents processing key generation server 600 generates a user CID based on the log-in information of the user who requested to generate the user CID (S205), and the CEK generator 620 generates a CEK for encrypting the contents (S206). The generated information is respectively stored in the CID generator 610 and the CEK generator 620, and the contents processing key generation server 600 transmits corresponding information to the DRM packager 404 through the contents processing key receiver 406 (S207).

The DRM packager 404 encrypts the UCC based on the user CID and the CEK received from the contents processing key generation server 600 (S208), and transmits them to the contents reproducer 410 to reproduce the UCC (S209).

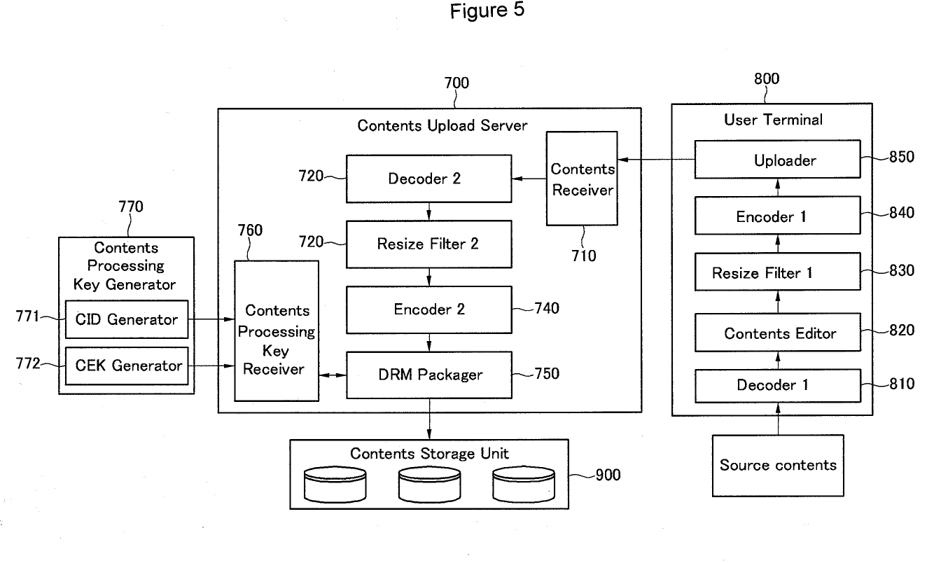

A contents protection device for encoding the UCC between a user terminal and a contents upload server according to a third exemplary embodiment of the present invention will now be described with reference to FIG. 5.

FIG. 5 is a configuration diagram for a contents protection system according to a third exemplary embodiment of the present invention.

The contents protection system is realized so that a user terminal 800 encodes the UCC into a standard format and a contents upload server 700 encodes the encoded UCC into a predetermined format again, thereby reducing the load provided to the user terminal 800 and the contents upload server 700. The user terminal 800 includes a first decoder 810, a contents editor 820, a first resize filter 830, a first encoder 840, and an uploader 850. Also, the contents upload server 700 includes a contents receiver 710, a second decoder 720, a second resize filter 730, a second encoder 740, a DRM packager 750, and a contents processing key receiver 760. The contents upload server 700 is linked with a contents processing key generator 770 and a contents storage unit 900 as well as the user terminal 800.

The contents processing key generator 770 is illustrated to be provided outside the contents upload server 700 in FIG. 5, and without being restricted to this, it can be realized inside the contents upload server 700.

The user terminal 800 encodes UCC according to the standard format that is predefined when realizing the contents protection system. In this instance, the user terminal 800 does not encrypt the generated UCC by using the DRM. Here, the standard format is QVGA/H.264, but it is not restricted thereto.

That is, the user terminal 800 checks the codec of the source contents generated through the first decoder 810, and generates the UCC to be uploaded from the source contents through the contents editor 820. The first resize filter 830 resets the size of the generated UCC so that the UCC may be reproduced in the site or the user terminal in which a predetermined viewer is installed, and the first encoder 840 encodes the UCC by using the QVGA/H.264 and transmits the encoded UCC to the contents upload server 700 through the uploader 850.

The contents upload server 700 receives the UCC that are encoded into the standard format by the user terminal 800 through the contents receiver 710, and performs secondary conversion thereon. Here, the secondary conversion is to encode the UCC according to the corresponding format when the site that is reproducing the UCC reproduces the UCC by using a format other than the standard format.

That is, it is required to convert the UCC according to the format of the site in which the UCC are executed since various sites in which the UCC are executed do not reproduce the UCC by using the same format. In this instance, the format used for secondary conversion includes the quarter video graphics array (QVGA) and the quarter common intermediate format (QCIF) as the video format, and it includes the moving picture experts group (MPEG4), H.264, and the MPEG-1 audio layer 4 (MP4) as the audio format.

The contents receiver 710 receives first converted UCC from the user terminal 800 to transmit the UCC to the second decoder 720, and the second decoder 720 checks the video format and the audio format of the first converted UCC. The second resize filter 730 resets the first converted UCC into the size to be actually reproduced, and the second encoder 740 encodes the UCC into the video format and the audio format supported by the site in which the UCC will be reproduced.

The DRM packager 750 receives the encoded UCC and encrypts the UCC based on the user CID information and the CEK received from the contents processing key generator 770. The contents storage unit 900 stores the converted UCC for their respective formats.

When the first conversion on the contents is performed by the user terminal 800 and the secondary conversion is performed by the contents upload server 700, the encoding on the newly added format is performed by the contents processor, and hence, less load is provided compared to the case of processing all conversions by the user terminal 800 or the contents upload server 700.

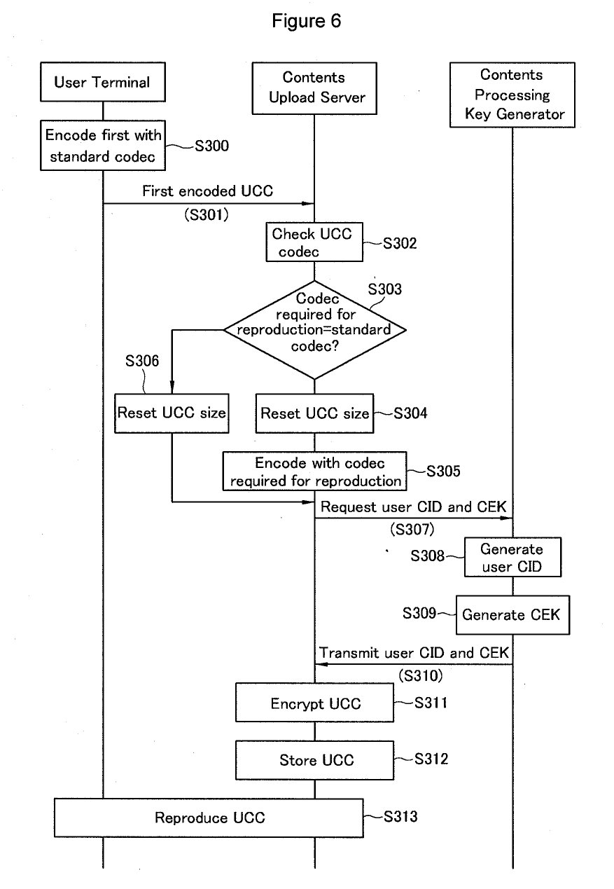

A UCC protection method based on the above-described constituent elements will now be described with reference to FIG. 6.

FIG. 6 is a flowchart for a contents protection method according to a third exemplary embodiment of the present invention.

As shown in FIG. 6, the first encoder 810 of the user terminal 800 performs first encoding on the UCC that are generated through the contents editor 820 by using the standard codec predefined in the system design (S300), and transmits the UCC to the contents upload server 700 (S301). The QVGA/H.264 will be described as a standard codec in the exemplary embodiment of the present invention, and the present invention is not restricted thereto.

The first encoded UCC that are received from the user terminal 800 through the contents receiver 710 are input to the second decoder 720, and the second decoder 720 checks the codec information used for first encoding (S302). The second decoder 720 checks the above-noted codec information and codec information required for reproducing the UCC in the site to which the UCC will be uploaded by the user or in the user terminal 800 from which the UCC will be reproduced through downloading (S303).

When the two types of codec information correspond to each other, the second resize filter 730 resets the size of the UCC (S306), and transmits the UCC to the DRM packager 750 so as to encrypt the UCC. However, when the two types of codec information do not correspond to each other, the size of the UCC is reset through the second resize filter 730 (S304) and secondary encoding is performed with the codec used for reproducing the UCC in the second encoder 740 (S305).

The DRM packager 750 requests a user CID and a CEK from the contents processing key generator 770 (S307). When receiving a request on the user CID and the CEK from the DRM packager 750, the CID generator 771 and the CEK generator 772 generate a user CID based on the user information of the logged-in user (S308), and generate a CEK for encrypting the UCC (S309).

The generated user CID and the CEK are transmitted to the DRM packager 750 (S310), and the DRM packager 750 encrypts the UCC based on the received information (S311). The encrypted UCC are stored in one contents storage unit 900 from among a plurality of contents storage units 900 according to the codec used for secondary encoding (S312), and the user terminal 800 and the contents upload server 700 reproduce the encrypted UCC (S313) and provide them to the user.

By performing first encoding on the UCC by the user terminal 800 and performing secondary encoding thereon by the contents upload server 700 as described above, the load that occurs during encoding can be reduced when the UCC are reproduced in a plurality of sites having various types of codec information. Also, even when a new codec for reproducing the UCC is generated, corresponding conversion can be performed by the contents upload server 700.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A contents protection system in a system for protecting user created contents generated by a user terminal, the contents protection system comprising:
a decoder for checking encoding information on first user created contents generated by the user terminal;
a resize filter for resetting the size of the first user created contents to be reproducible;
an encoder for encoding the first user created contents by using codec information supported by a predetermined viewer and outputting second user created contents so that the first user created contents with the reset size may be reproduced under a condition in which the predetermined viewer is installed; and
a packager for encrypting the output second user created contents by using contents identification (CID) information and a encryption key that is generated based on provider information of the first user created contents.

2. The contents protection system of claim 1, further comprising:
a contents receiver for receiving the first user created contents from the user terminal;
a contents processing key generator for generating the CD information and the encryption key used for encrypting the second user created contents by the packager;
a contents key receiver for transmitting the CID information and the encryption key generated by the contents processing key generator to the packager; and
a contents storage unit for storing the second user created contents that are encrypted and output by the packager.

3. The contents protection system of claim 2, wherein
the contents processing key generator includes:
a user CID generator for generating the CID information based on user information of the user having logged in to the contents protection system through the user terminal so as to generate the first user created contents, and storing the generated CID information and the user information to correspond with each other; and
a contents encryption key generator for generating the encryption key for encrypting the second user created contents.

4. The contents protection system of claim 1, wherein
the first user created contents and the second user created contents are encoded based on one of encoding information including quarter video graphics array (QVGA), quarter common intermediate format (QCIF), MPEG-1 audio layer 4 (MP4), and H.264.

5. A contents protection method in a method for protecting user created contents generated by a user terminal, the contents protection method comprising:
checking codec information applied to first user created contents generated through the user terminal;
encoding the first user created contents and outputting the encoded first user created contents as second user created contents by using codec information for reproducing the first contents under a condition in which a predetermined viewer for reproducing the first user created contents is positioned;
receiving contents identification (CID) information corresponding to the first user created contents and a contents encryption key corresponding to the second user created contents, the CID information being generated based on user information on the user having generated the first user created contents; and
encrypting and outputting the second user created contents based on the CID information and the contents encryption key.

6. The contents protection method of claim 5, wherein
the step of outputting the second user created contents includes:
resetting the first user created contents as a predetermined size so as to reproduce the first user created contents in an environment in which the predetermined viewer is positioned; and
encoding the contents based on coding information required for contents reproduction by the viewer, and converting and outputting the first user created contents as the second user created contents.

7. The contents protection method of claim 5, wherein
the step of receiving the contents encryption key includes:
determining whether the second user created contents are encrypted and stored;
requesting to generate the CID information and the contents encryption key when the second user created contents are not stored; and
receiving the CID information that is generated based on user information of the user having generated the first user created contents and the contents encryption key that is randomly generated corresponding to the second user created contents.

8. The contents protection method of claim 7, wherein the method includes:
receiving CID information on the second user created contents included in a contents identifier for the second user created contents when the second user created contents are stored; and
receiving the contents encryption key that is randomly generated corresponding to the second user created contents.

9. A contents protection system in a system for protecting user created contents, the contents protection system comprising:
a contents processor for converting first user created contents generated from source contents into second contents and outputting the second contents so as to be reproduced in a predetermined viewer; and
a contents reproducer for receiving the second user created contents from the contents processor, and reproducing the second user created contents through the predetermined viewer, wherein
the contents processor includes a packager for encrypting the second user created contents based on the CID information and the contents encryption key to generate the encrypted second user created contents.

10. The contents protection system of claim 9, wherein
the contents processor further includes:
a contents editor for generating the first user created contents from the source contents;
an encoder for checking codec information for forming the generated first user created contents;
a transcoder for encoding the first user created contents by using codec information provided by the predetermined viewer so that the first user created contents may be reproduced in the predetermined viewer, and generating the second user created contents;
an uploader for providing the encrypted second user created contents generated by the packager to an environment in which a predetermined viewer for reproducing the encrypted second user created contents is installed; and
a contents key receiver for receiving the CID information and the contents encryption key.

11. The contents protection system of claim 9, wherein
the contents reproducer includes:
a server interface for receiving a right object and metering information generated corresponding to the contents;
a digital rights management (DRM) core for managing the right object, the metering information, and the format of the contents; and
a secure storage for storing the right object, the metering and the contents encryption key used for encrypting the contents.

12. The contents protection system of claim 10, further including:
a contents upload server for receiving the encrypted second user created contents received through the uploader, and storing the encrypted second user created contents so that the encrypted second user created contents may be reproduced in the predetermined viewer; and
a contents processing key generation server for generating the CID information and the contents encryption key.

13. The contents protection system of claim 12, wherein
the contents processing key generation server includes:
a user CID generator for generating the CID information based on user information of the user having logged in to the contents protection system through the user terminal so as to generate the first user created contents, and storing the generated CID information and the user information to correspond with each other; and
a contents encryption key generator for generating the encryption key for encrypting the second user created contents.

14. A contents protection method in a method for protecting user created contents generated from a user terminal, the contents protection method comprising:
performing first conversion on the contents generated by the user terminal based on predetermined codec information and outputting first user created contents;
receiving codec information required for reproducing the contents through a predetermined viewer from a contents reproduction server in which the predetermined viewer is installed, and comparing the codec information and the predetermined codec information;
encoding the first user created contents based on the codec information when the predetermined codec information does not correspond to codec information required for reproducing contents through the viewer, and generating second user created contents to thus perform secondary conversion; and
receiving a CID corresponding to the generated first user created contents and a contents encryption key corresponding to the second contents, and encrypting the second user created contents.

15. The contents protection method of claim 14, wherein
the step of performing secondary conversion includes:
resetting the first user created contents to a size that is predetermined by the viewer so that the first user created contents may be reproduced in the viewer; and
encoding the size reset first user created contents by using codec information required by the viewer.

16. The contents protection method of claim 15, wherein
the first conversion is performed in the user terminal, and the secondary conversion is performed in the contents upload server.
